(19) United States
(12) Patent Application Publication
(10) Pub. No.: US 2011/0229696 A1
(43) Pub. Date: Sep. 22, 2011

(54) DOCUMENT OF VALUE AND METHOD FOR DETECTING SOIL OR WEAR LEVEL

(75) Inventors: Rohan Ratnukumar, Basingstoke (GB); Jane Haley, Hedge End (GB); Paul Howland, Andover (GB)

(73) Assignee: DE LA RUE INTERNATIONAL LIMITED, Basingstoke, Hampshire (GB)

(21) Appl. No.: 13/059,505

(22) PCT Filed: Aug. 12, 2009
(86) PCT No.: PCT/GB2009/001978

§ 371 Date: Jun. 3, 2011

(30) Foreign Application Priority Data
Aug. 28, 2008 (GB) PCT/GB2008/002904

(51) Int. Cl. B32B 3/30; B41F 33/00; G01J 5/10; G01N 21/55; B41M 3/14; B32B 3/10; B44F 1/12

(52) U.S. Cl. 428/172; 101/483; 250/340; 356/445; 427/7; 428/195.1; 428/201

(57) ABSTRACT

A document of value is provided comprising a soil or wear level test feature for determining whether the document of value is soiled. The soil or wear level test feature comprises: a reference area comprising a first region of the document; and a measurement area comprising a second region of the document. The reflectance of the measurement area is affected differently by the presence of soil or wear to that of the reference area, such that the difference in reflectance between the reference area and the measurement area provides an indicator of the degree of soiling or of the degree of wear of the document of value. Also provided is a method for detecting the soil or wear level of a document of value.

This invention relates to documents of value such as currency, banknotes, identification documents, passports and certificates, and in particular is concerned with detecting the soiling and/or wearing of such documents to determine whether the document remains fit for use. The description below will focus on the application of the invention to banknotes, but it will be appreciated that the same concept can be extended to any document of value.

The banknote cycle comprises the following elements:
a) new notes are issued into circulation via the banking system;
b) consumers use the banknotes for transactions and eventually they are returned to the banking system;
c) central banks and/or commercial banks sort the returned notes into two categories: those fit for re-issue, and those that have become worn or soiled to the point where they are no longer fit for circulation.

It is essential that the sorting stage (c) is highly accurate, to ensure that fit notes are not incorrectly categorised as unfit for re-issue.

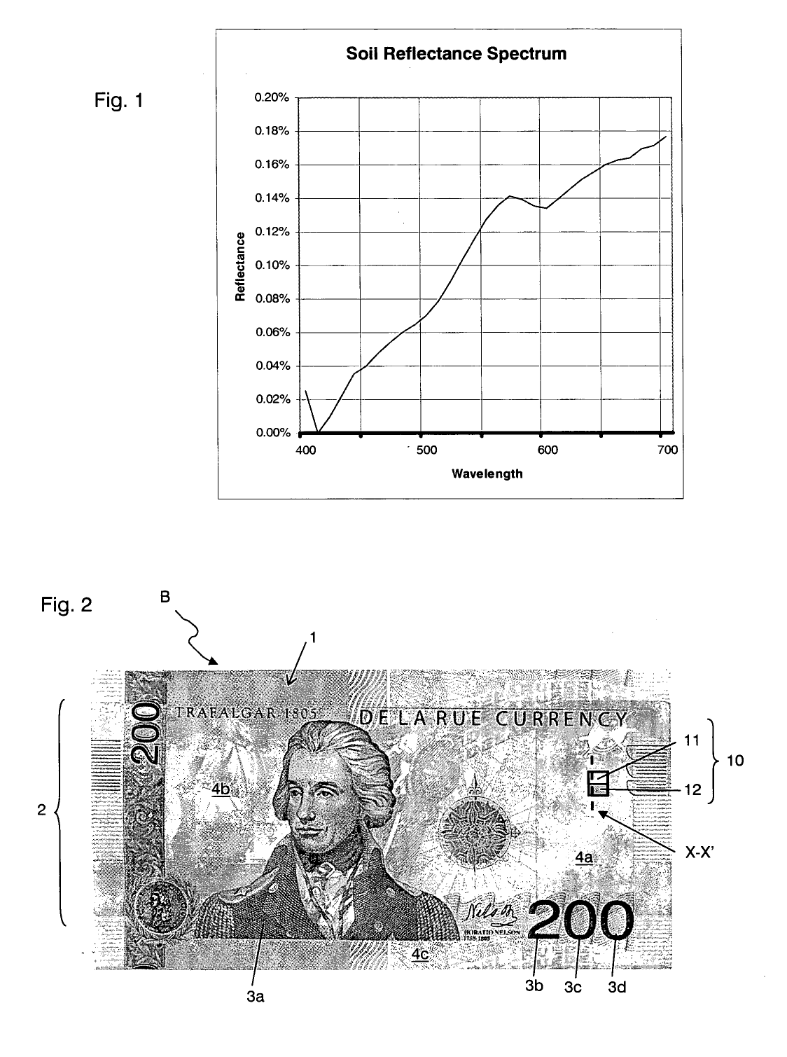

One of the key fitness criteria is how soiled (dirty) a banknote is. The term “soil” covers any substance which may be deposited onto a banknote and affect the appearance thereof. Thus a soiled banknote generally exhibits a change in colour (relative to the original unsoiled document) due to the addition of a stray substance such as skin oils or dirt. However soiling could also be due to the addition of individual marks such as graffiti (i.e. pen/pencil) or stains, which may be deliberate or not. The spectral response of soil on banknotes from different parts of the world and from one note to another is remarkably consistent, having a yellow hue as shown in FIG. 1. It has also been found that, except in the case of one-off stains such ink marks and drink spillages, soil is remarkably uniformly distributed across the surface of banknotes.

Conventionally, soil level is estimated by measuring the reflectivity of a banknote in an area containing little or no print. A typical process involves:
a) illuminate the note with a monochromatic light;
b) identify the most reflective areas of the note (usually a defined percentage of the note area);
c) calculate the average reflectance in these areas;
d) compare the result with accept/reject criteria (such as a predetermined reflectance threshold); and
e) sort the note to the appropriate pocket or shredder depending on the result of the comparison.

Variations of this known technique include illumination by white light and the use of a colour filter in front of the light detector, illuminating in other parts of the non-visible spectrum such as infrared, and using more than one wavelength to make the accept/reject decision.

Examples of such conventional processes are given in WO-A-2008/058742, US-A-2006/0140468 and EP-A-1785951, amongst others.

The conventional techniques rely on the fundamental assumption that, in their unsoiled state, any particular set of secure documents (e.g. a particular denomination of a series of banknotes) should have a consistent measurable reflectance whatever wavelength is selected. However, in practice, it has been found that the reflectance of individual unsoiled secure documents varies due to a number of factors, including:
a) variation in specular reflectance from one batch to the next and even between documents in one batch, due to differences in paper smoothness;
b) variation in reflectance due to discrepancies in substrate colour and opacity;
c) variation in reflectance due to discrepancies in print density over the regions of the document used for determining the degree of soiling; and
d) in the case of paper substrates, variation in fibre furnish due to degree of refining, type of fibre (such as abaca, linter and woodpulp) used and proportion of different fibre types used.

Together, variations in substrate and print lead to a significant difficulty in controlling the reflectance of the unsoiled document. This can lead to some acceptable documents being incorrectly designated as unfit and, conversely, some highly soiled documents passing conventional fitness tests.

The substrate and print variation issues which lead to these problems are most prevalent in a currency operating a “clean note” policy (i.e. applying a relatively low soiling threshold at which notes will be destroyed), and when there are notes of a given denomination in circulation from a variety of production batches and/or multiple suppliers.

Another key fitness criteria, closely related to the soil level, is the level of wear which has been suffered by a document. ‘Wear’ is the loss of print from a document due to ink abrasion caused by repeated handling of the document. Overly worn documents also need to be accurately identified and removed from circulation. Polymer-based banknotes are particularly susceptible to wear.

What is needed is a technique for identifying soiled or worn secure documents, particularly banknotes, which does not suffer from the aforementioned problems.

In accordance with the present invention, a document of value comprises a soil or wear level test feature for determining the soil or wear level of the document of value, the soil or wear level test feature comprising:

a reference area comprising a first region of the document; and

a measurement area comprising a second region of the document;

wherein a property of the measurement area is affected by the presence of soil or wear differently to the same property of the reference area, such that the difference in the property between the reference area and the measurement area provides an indicator of the degree of soiling or of the degree of wear of the document of value.

The invention further provides a method of detecting the soil or wear level of a document of value, comprising:
a) measuring a property of a reference area of the document, the reference area comprising a first region of the document;
b) measuring the same property of a measurement area of the document, the measurement area comprising a second region of the document, wherein the property of the measurement area is affected differently by the presence of soil or wear to that of the reference area; and
c) calculating the difference between the measured property of the reference area and the measured property of the measurement area, the calculated difference providing an indicator of the degree of soiling or the degree of wear of the document of value.

The invention also provides an apparatus adapted to perform the above method, and a computer program product containing instructions for performing the method.

By measuring a property in two areas on the document and using the difference between the two measurements as a measure of soiling or wear, the resulting parameter is largely independent of variations in the substrate or the banknote print. This is because the two regions of the document are affected by any such variations to an equal extent. Subtracting the property value of the reference area from the corresponding property value of the measurement area (or vice versa) therefore removes the effect of the substrate and background print from the parameter and overcomes the problems experienced using conventional techniques.

By arranging for the reference and measurement areas to be affected differently by the presence of soil or wear, as the soiling level increases, the difference in the measured property will also change. This allows the difference in property to act as an indicator of soiling or wear level. Depending on the particular property measured, i.e. whether it is affected by soil and/or wear, the difference obtained will provide a direct indication of either soil level or wear level or a combination of the two. However, it has been found that the degree of soiling exhibited by a document typically increases in step with the degree of wear and as such both an indication of soil level and of wear level can, if desired, be deduced from a single property.

The substrate of the secure document could comprise paper or polymer, or a combination thereof.

Preferably, the property of the measurement area is affected by the presence of soiling or wear to a greater extent than that of the reference area. However in other examples, the two areas could be affected to similar extents but in different ways, e.g. the reflectance of each could undergo a wavelength shift. In other examples, the reference area could be affected more than the measurement area.

Preferably, the property of the measurement area changes faster than that of the reference area as the degree of soiling increases.

In particularly preferred embodiments, the property of the measurement and reference areas which is measured is their reflectance. However, any measurable property that is affected by soiling and/or wear could be used, including transmittance, light scatter, gloss, roughness, luminescence, fluorescence, magnetism, or thermal emissivity.

It should be noted that the value of the selected property need not be continuous over the whole surface of the reference or measurement area. For example, one or both regions could be provided with a line structure, where the lines possess the requisite property (e.g. those of the reference area having a reflectance which is affected by soil or wear less than those of the measurement area). In this case, a representative property measurement may be taken of each whole region (or parts thereof). For instance in the above example, a portion of the reference area including both lines and the spaces therebetween might be arranged to fill the field of view of the detector, such that the detector records a reflectance value which results from the combination of lines and the spaces between.

In preferred embodiments, the document of value further comprises a substrate and a graphics layer thereon having one or more printed images extending over at least part of the surface of the document of value, the graphics layer being disposed between the soil or wear level test feature and the substrate, or over the soil or wear level test feature. That is, the soil level or wear test feature is not part of the graphics layer but is applied separately. Whether the soil or wear level test feature is applied before or after printing depends on its nature. In many cases, providing the soil or wear level test feature over any printing on the document helps to ensure the result of the property comparison is independent of the graphics, and allows the feature to be added to the document retrospectively.

Since the property of each area must be separately measurable, it is preferred that the first and second regions do not overlap one another. However, in certain embodiments it may be desirable for parts of the regions to overlap, e.g. for aesthetic purposes. In these cases the property (e.g. reflectance) may be measured from a non-overlapping portion of each region.

Preferably, the first and second regions are disposed adjacent to one another, preferably spaced apart by not more than approximately 10 mm, still preferably no more than approximately 5 mm and most preferably no more than approximately 2 mm. Placing the two portions adjacent to one another on the document improves the accuracy of the soil or wear level indication, because the two regions are likely to have experienced the same wear and so accumulated a very similar level of soiling and/or wear. However, in other embodiments it may be preferred to have the two regions spaced from each other on the document, for example to fit in with an aesthetic design. Nonetheless, in particularly preferred embodiments, the first and second regions abut one another.

Advantageously, each of the first and second regions is elongate substantially parallel to an edge of the document of value. This allows a detector to view each region for an extended duration (and so obtain a more accurate result), since the movement direction of a document past the detector in a sorting machine will typically be parallel to one of the document's edges. For example, in a banknote sorting machine, banknotes will typically be conveyed either long edge first or short edge first. To enable the banknote to be tested using either machine configuration, elongate regions of the soil or wear test feature may be provided both parallel to the long edge and parallel to the short edge.

Preferably, at least a portion of each of the first and second regions has a width of at least approximately 2 mm. This has been found to provide a suitable surface area for obtaining an accurate measurement using currently available detectors. However, should higher-resolution detectors become available, the dimensions of the regions could be reduced.

In certain advantageous embodiments, the first region comprises a plurality of first sub-regions collectively forming the reference area, and/or the second region comprises a plurality of second sub-regions collectively forming the measurement area. This allows each region to be discreetly disposed on the document over a large total area but without the need for a large, obtrusive feature. The use of a large total area improves the accuracy of the soil level indication since a greater part of the document is tested. Preferably, the first sub-regions are interspersed with the second sub-regions.

In preferred embodiments, a plurality of soil or wear level test features spaced apart from one another may be provided on the document of value. This makes it possible to test the soiling or wear level of several parts of the document and so obtain a more accurate indication of soiling or wear.

In a preferred implementation, the first region is printed with a first colour reflecting primarily at wavelengths of above 550 nm to form the reference area, and the second region is printed with a second colour reflecting primarily at wavelengths of below 550 nm to form the measurement area. Since soil has a yellow hue, it reflects primarily at wavelengths above 550 nm. The measured property in this implementation is reflectance. As both regions get increasingly soiled, the reflectance of the measurement area will therefore decrease quickly since its intrinsic reflectance (less than 550 nm) will be absorbed by the soil. The reflectance of the reference area will undergo relatively little change since it has a similar intrinsic reflectance to that of soil.

Preferably, the first colour is yellow and the second colour is blue. However, it is possible to use other colour combinations. For example the first colour could be yellow and the second colour white (which reflects at all wavelengths in the visible spectrum). Indeed, for the measurement area, any colour which is sufficiently different to that of soil could be used. In contrast, the reference region should preferably be close to the colour of soil, and yellow is the preferred choice for this.

Further, both regions could be very lightly printed, with one colour closely matching the colour of the paper. Other colour combinations are possible and may be desired for ease of integration into the design.

Preferably, the first and second regions are printed with substantially equal optical density. In particularly preferred embodiments, the opacity of the first and second regions is sufficient such that neither any print underneath the soil level test feature, nor the substrate of the document, contributes substantially to the reflectance of the first or second regions. These measures help to improve the accuracy of the soil level indication.

Advantageously, the first and second regions are elongate substantially parallel to an edge of the document of value and to each other. Preferably, two such soil level test features are provided, a first having the first and second regions elongate substantially parallel to a first edge of the document of value, and a second having the first and second regions elongate substantially parallel to a second edge of the document, which is perpendicular to the first edge. Such arrangements assist the detector in obtaining accurate reflectance measurements. In preferred embodiments, the first region comprises two first sub-regions elongate and parallel to one another, and the second region comprises two second sub-regions elongate and parallel to one another.

It should be noted that when the measurement and reference areas are each provided in separate line structure formats (or other format involving sub-regions), preferred measurement methods will measure both the line property and that of the region between the lines, as mentioned above. Since both the measurement and reference areas will be identically affected by the presence of spaces between the lines, the difference between these values which is the measure of soil will still be unaffected by variations in background colour.

In another preferred implementation, the surface of the document in the first region is adapted to have a lower affinity for soil than that in the second region. In this way, more soil collects on the second region than on the first region during normal use. Thus the reflectance of the second region changes relatively rapidly compared with that of the first region as soiling increases. Other properties of the regions could be measured in place of reflectance, but in this example, reflectance is preferred.

The first region may be adapted to have a lower affinity for soil by the application of a soil resistant film. This film may be a varnish or coating and can be applied to the document substrate before or after printing (or both). It has been found that either arrangement leads to reduced soiling. Alternatively the film may be an area of a material that has high or low surface energy or a patch or strip of polymer film or thread.

Alternatively, the region may be adapted to have a lower affinity for soil by creating a smooth region of the document by application of a compressive force through calendaring, embossing or intaglio printing, for example.

Any combination of these features may be used for the production of the soil or wear level indicator feature.

In a particularly advantageous embodiment, the first region is coated with a layer of varnish, the thickness of which is greater than that of any varnish layer in the second region. Varnish (or lacquer) presents a relatively smooth surface compared with the uncoated substrate of the document, and therefore collects less soil than unvarnished regions. Also, it has been found that soil adhesion decreases as the thickness of the varnish layer increases: hence, a region of relatively thick varnish will collect less soil than a region of relatively thin varnish. Therefore this technique can be used successfully both for generally unvarnished documents and documents which include a protective coating layer. In preferred examples, if varnish is present in both the first and second regions, its thickness in the second region (measurement area) is approximately half that of the first region.

Preferably, the first and second regions are each arranged to coincide with optically equivalent areas of the document. That is, any print either above or below the coating in the reference region is preferably of substantially the same appearance as that either above or below the coating in the measurement region. Similarly, if the substrate is known to vary in appearance across the document, the reference and measurement regions should be placed in areas of the substrate having substantially the same appearance. This can be achieved in various ways. Generally, it is preferred that the first and second regions are each arranged in (one or more) unprinted areas of the document, or the two regions could be arranged in (one or more) printed areas each having substantially the same colour and print density as one another.

For example, the first and second regions may be disposed over a background image or an unprinted portion of the graphics layer. In other preferred embodiments, the first and second regions may be disposed over one or more indicia images of the graphics layer, the or each indicia image preferably having a minimum dimension of at least 2 mm. For example, in a banknote having an indicia reading “10”, both regions may be disposed over one of the numerals (i.e. the “1” or the “0”), or one region could be disposed over the “1”, and the other over the “0”. Since varnish is typically transparent or translucent, arranging the feature over relatively uniform areas of the document (as compared with one another) improves the accuracy of the soil indication.

In another preferred embodiment, the first region is smoothed by calendaring or embossing (and the second region is preferably not smoothed), such that the surface of the document is smoother in the first region than in the second region. As in the case of varnish, calendaring or embossing provides a relatively smooth surface which will collect less soil than unsmoothed regions of the document.

In another preferred implementation, the surface of the document in the second region is raised relative to that in the first region. Raised regions have been found to collect more soil relative to lower (either flat or depressed) regions of the document, since these are the regions which will have greater contact during handling. It is preferred that the reflectance of each region is detected as the measured property, but alternative properties could be used instead.

Preferably, the soil level test feature comprises a watermark, the first region having lower fibre density than that of the second region, or an embossing, the first region comprising a portion of the document distorted below the plane of the document, and the second region comprising a portion of the document distorted above the plane of the document.

Advantageously, in the case of a watermark the first and second regions each have a narrow dimension which is less than approximately 4 mm, preferably less than or equal to approximately 2 mm. This is primarily because, due to natural variations in the papermaking process, it is difficult to produce a watermark with a large planar area with a uniform paper grammage.

In preferred embodiments, the first region comprises a plurality of first sub-regions, each having a narrow dimension which is less than approximately 4 mm, preferably less than or equal to approximately 2 mm, and/or the second region comprises a plurality of second sub-regions, each having a narrow dimension which is less than approximately 4 mm, preferably less than or equal to approximately 2 mm. This allows a large area of the document to be tested whilst keeping each individual sub-region within the size limits discussed above.

In another preferred implementation, the second region comprises a frangible structure adapted to wear relatively fast compared to the first region of the document. As already noted, it has been found that wear on a document increases as soiling increases, and so a measure of wear can be used to give an indication of soiling level (or vice versa). By arranging for the frangible structure to have a reflectance different from that of the first region of the document, the amount of wear can be deduced from a comparison of the reflectances (or other selected property).

Preferably, the second region comprises a lower layer of first reflectance, and an upper layer thereon of second reflectance differing from that of the lower layer, wherein the upper layer is relatively frangible compared to the lower layer. Advantageously, the first region comprises a layer of equal reflectance to that of the lower layer of the second region. Preferably, the first region layer is contiguous with the lower layer of the second region.

Advantageously, the frangible structure comprises frangible ink with a reduced binder content. Other methods of achieving a frangible structure include weakening the adhesion between the frangible layer and the lower layer. Preferably, the upper layer of the second region comprises frangible ink with a reduced binder content relative to that of the lower layer of the second region and the first region layer.

In particularly preferred embodiments, one or more layers of the frangible structure is infrared absorbing or reflecting. By selecting arrangements of IR absorbing and reflecting materials, the sensitivity of reflectance to wear is increased, since the change from IR reflecting to IR absorbing (or vice versa) is absolute and hence easily recognised.

Advantageously, the lower layer of the second region and the first region layer, and the upper layer of the second region, have substantially equal reflectances in the visible spectrum such that they are of similar appearance to a user. This allows the feature to be effectively hidden on the document.

In another preferred embodiment, the lower layer of the second region is X-ray transparent, and the upper layer of the second region is X-ray absorbent. Advantageously, the first region layer is X-ray transparent or X-ray absorbent. Combining X-ray active and IR-active materials is particularly preferred since detecting the presence (or absence) of each enhances the accuracy of the soil detection and improves the security of the document.

Preferably, the document of value is a banknote, certificate, passport or other security document.

The present invention also provides a method of making a document of value as described above, comprising:

providing a printed document of value comprising a graphics layer; and

applying a soil or wear level test feature to the printed document of value, the soil or wear level test feature comprising: a reference area comprising a first region of the document; and a measurement area comprising a second region of the document; wherein a property of the measurement area is affected by the presence of soil or wear differently to the same property of the reference area, such that the difference in the property between the reference area and the measurement area provides an indicator of the degree of soiling of the document of value.

The method of detecting the soil level of a document of value according to the invention (described earlier) could be used to simply allocate a soiling or wear level to the document. However the method preferably further comprises:
d) determining whether the calculated difference in measured reflectance meets predetermined criteria defining an acceptable soil or wear level.

Advantageously, the step of determining comprises comparing the calculated difference in measured reflectance to a predetermined difference threshold level.

The method preferably further comprises:
e) sorting the document of value based on the outcome of the determination.

Advantageously, documents meeting the predetermined criteria defining an acceptable soil or wear level are sorted to a store for recirculation, and documents not meeting the predetermined criteria are sorted to a store for destruction, preferably a shredder.

Preferably, the measured property of the reference and measurement areas is reflectance, transmittance, light scatter, gloss, roughness, luminescence, fluorescence, magnetism, or thermal emissivity.

Where the measured property is reflectance, preferably, in steps a) and b), the reflectance of the reference and measurement regions is measured at a selected waveband which is narrow compared to the visible spectrum. Advantageously, the waveband defines monochromatic radiation, preferably blue with a wavelength below 500 nm, or infrared with a wavelength between 750 nm and 1 mm.

Where the first region comprises a plurality of first sub-regions, preferably the step of measuring the reflectance of the first region comprises measuring the reflectance of at least some of the plurality of first sub-regions and computing an average reflectance. Similarly, where the second region comprises a plurality of second sub-regions, preferably the step of measuring the reflectance of the second region comprises measuring the reflectance of at least some of the plurality of second sub-regions and computing an average reflectance.

In preferred embodiments, at least some of the plurality of first sub-regions fall within the field of view of a detector such that they are measured simultaneously to arrive at the average property value. Preferably, any spaces between the at least some of the plurality of first sub-regions also fall within the field of view of a detector such that they are measured simultaneously with the at least some of the plurality of first sub-regions to arrive at the average property value.

Advantageously, the method of detecting the soil or wear level of a document of value further comprises:
i) measuring the absolute property value of the reference and/or the measurement areas;
ii) determining whether the absolute property value meets a reject criterion; and
iii) processing the document of value based on the outcome of the determination in step ii).

This additional test identifies documents having a very high soiling or wear level. It has been found that, in some circumstances, the difference in the measured property between reference and measurement areas begins to reverse above a certain soiling or wear level (for example, where a feature may undergo an increase in difference up to a certain soiling level, above that level the difference may begin to decrease). At such levels, the amount of soiling or wear is such that variations in paper and print are small in comparison to the effect of the soil or wear. Therefore, the absolute property value (e.g. the absolute reflectance) can be used to identify such documents without leading to any significant inaccuracies in the sort process.

Examples of documents having soil or wear level test features and methods of detecting the soil or wear level of such documents will now be described with reference to the accompanying drawings in which:—

FIG. 1 shows a typical reflectance spectrum obtained from soil commonly found on banknotes;

FIG. 2 shows a first embodiment of a document of value;

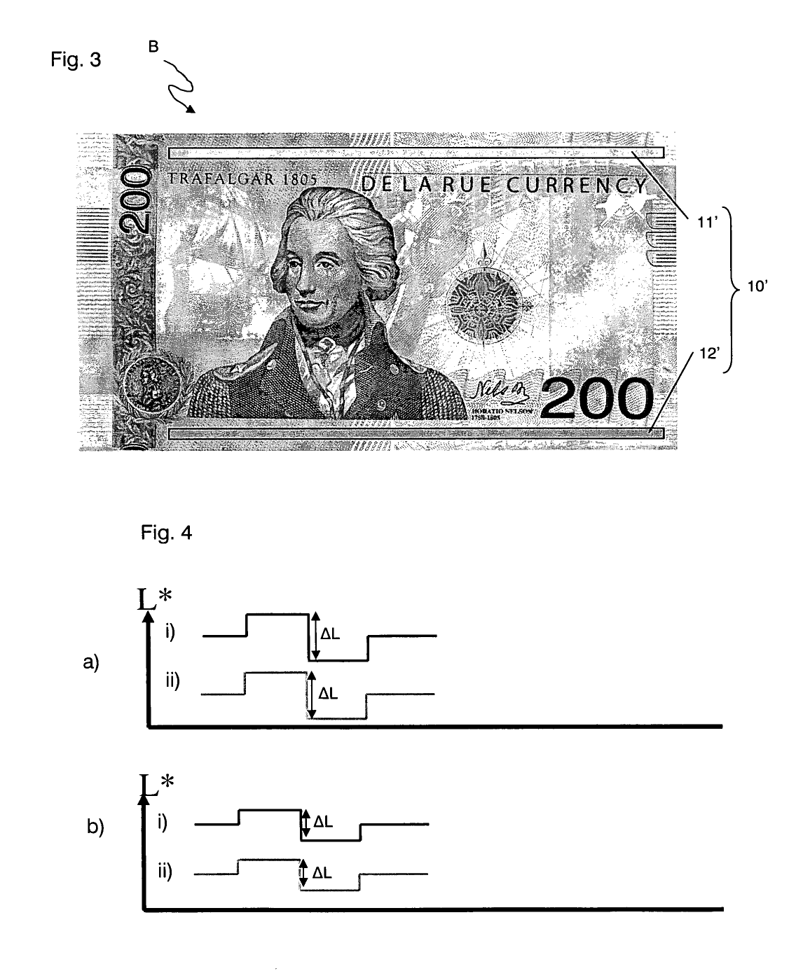

FIG. 3 shows a second embodiment of a document of value;

FIGS. 4a and 4b show reflectance across the surface of the document of FIG. 2, along line X-X′, when clean (4a) and when soiled (4b);

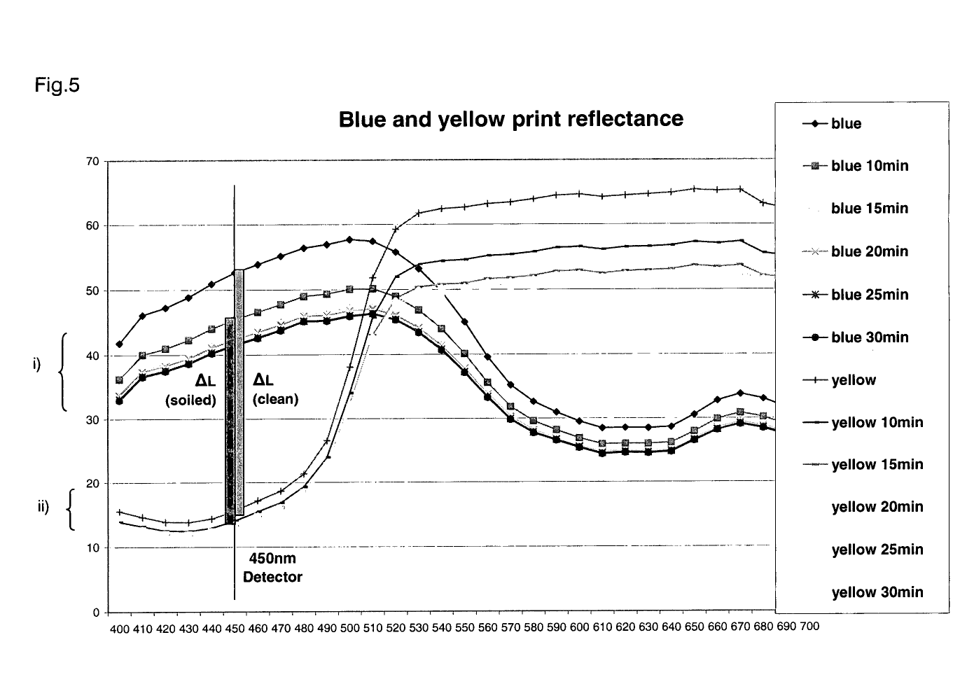

FIG. 5 shows the reflectance of the measurement and reference areas in the first and second embodiments versus wavelength;

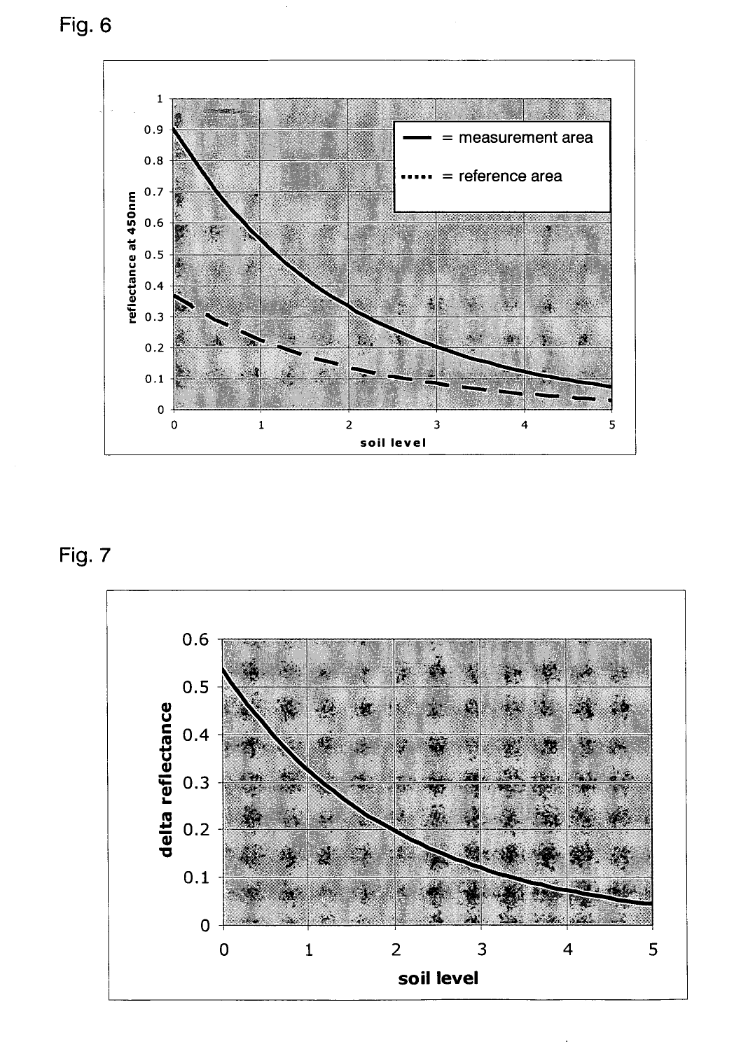

FIG. 6 shows the change in reflectance as soil level increases for an exemplary document according to the first embodiment;

FIG. 7 shows the change in the reflectance difference as soil level increases for the exemplary document of FIG. 6;

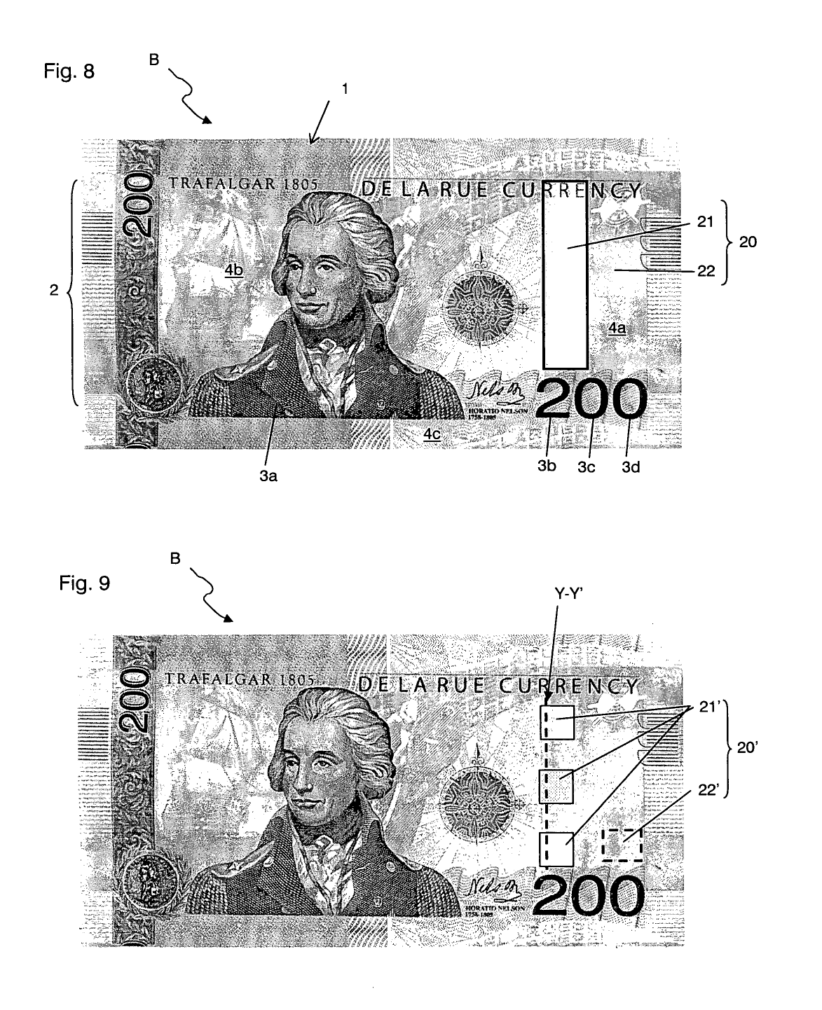

FIG. 8 shows a third embodiment of a document of value;

FIG. 9 shows a fourth embodiment of a document of value;

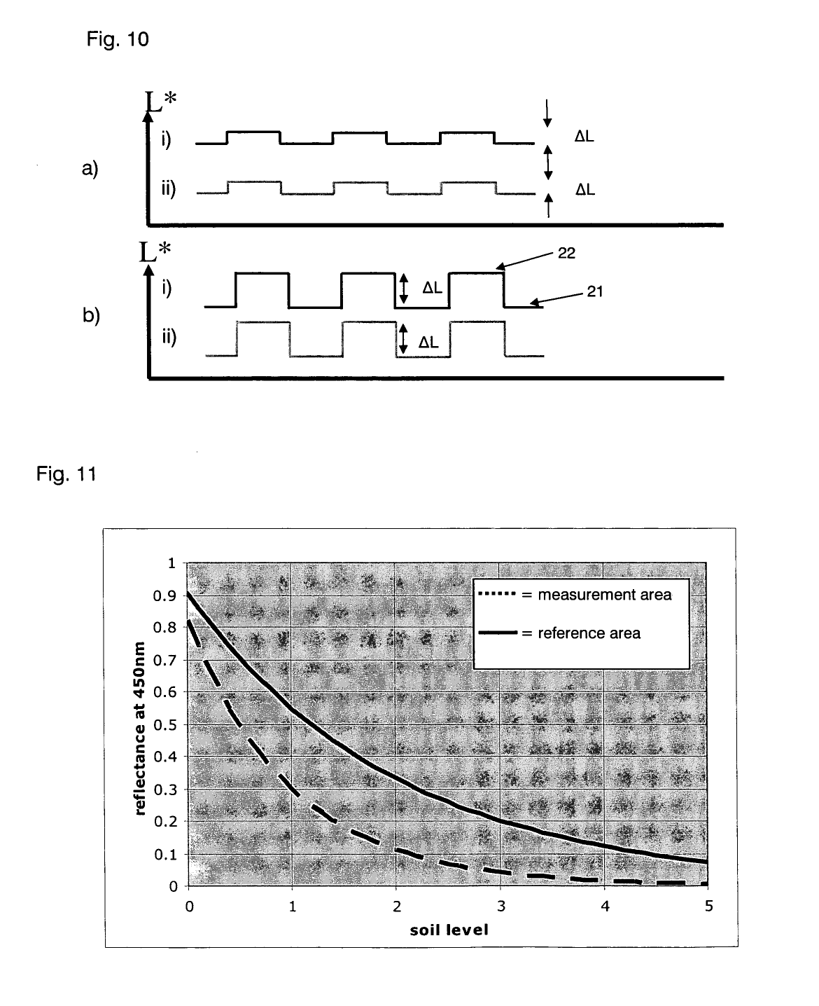

FIGS. 10a and 10b show the reflectance across the surface of the document of FIG. 9, along line Y-Y′, when clean (10a) and when soiled (10b);

FIG. 11 shows the change in reflectance as soil level increases for an exemplary document according to the fourth embodiment;

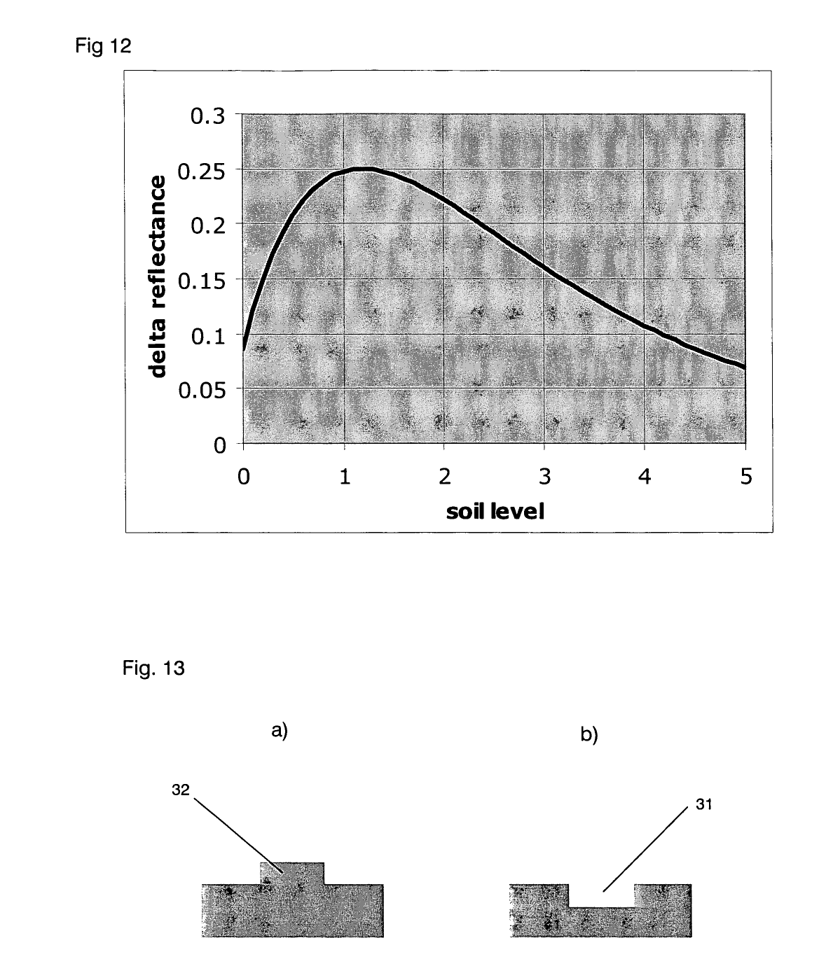

FIG. 12 shows the change in the reflectance difference as soil level increases for the exemplary document of FIG. 11;

FIG. 13 schematically shows a cross-section of watermark in a document, FIG. 13a showing a raised portion of the watermark and FIG. 13b showing a depressed portion of the watermark;

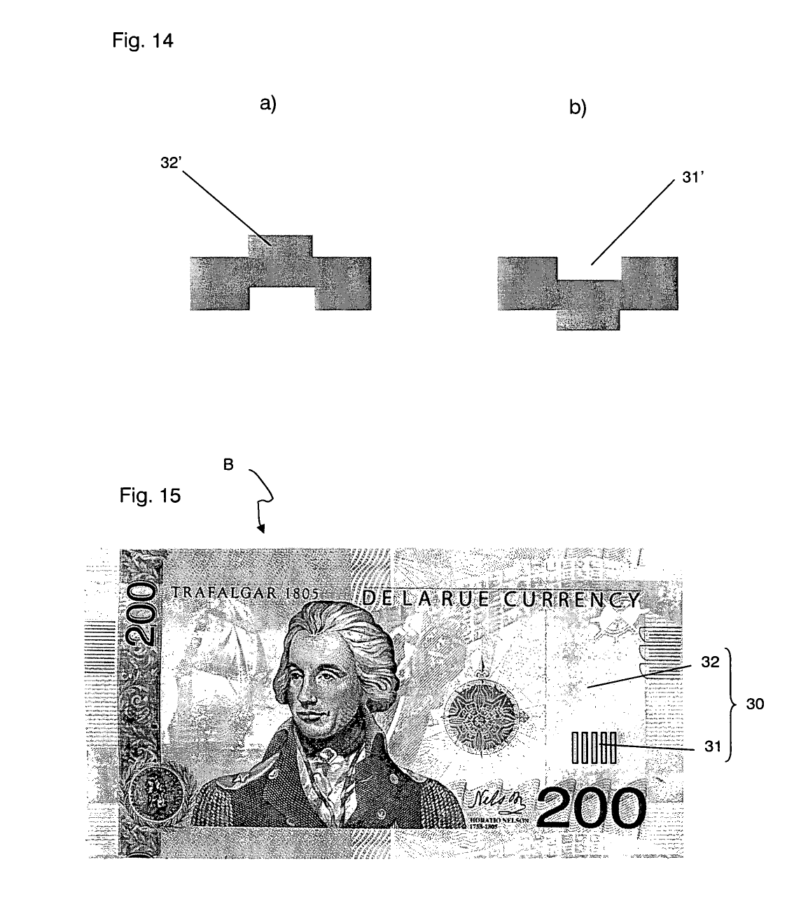

FIG. 14 schematically shows a cross-section through an embossed portion of a document, FIG. 14a showing a raised portion of the embossing and FIG. 14b showing a depressed portion of the embossing;

FIG. 15 shows a fifth embodiment of a document of value;

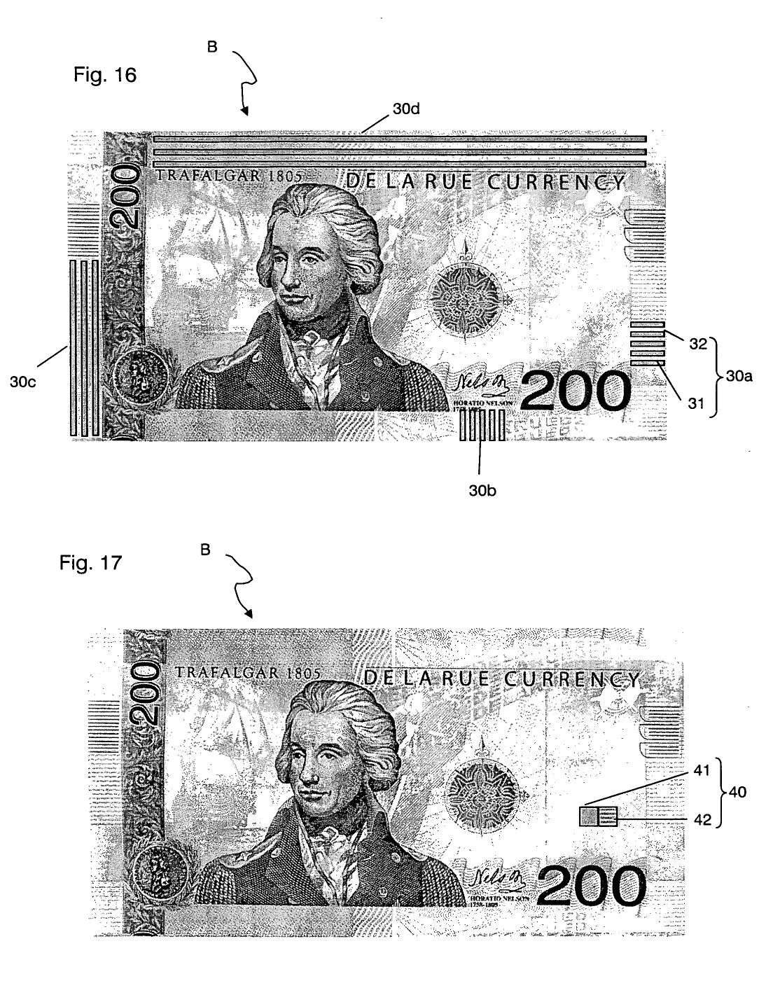

FIG. 16 shows a sixth embodiment of a document of value;

FIG. 17 shows a seventh embodiment of a document of value;

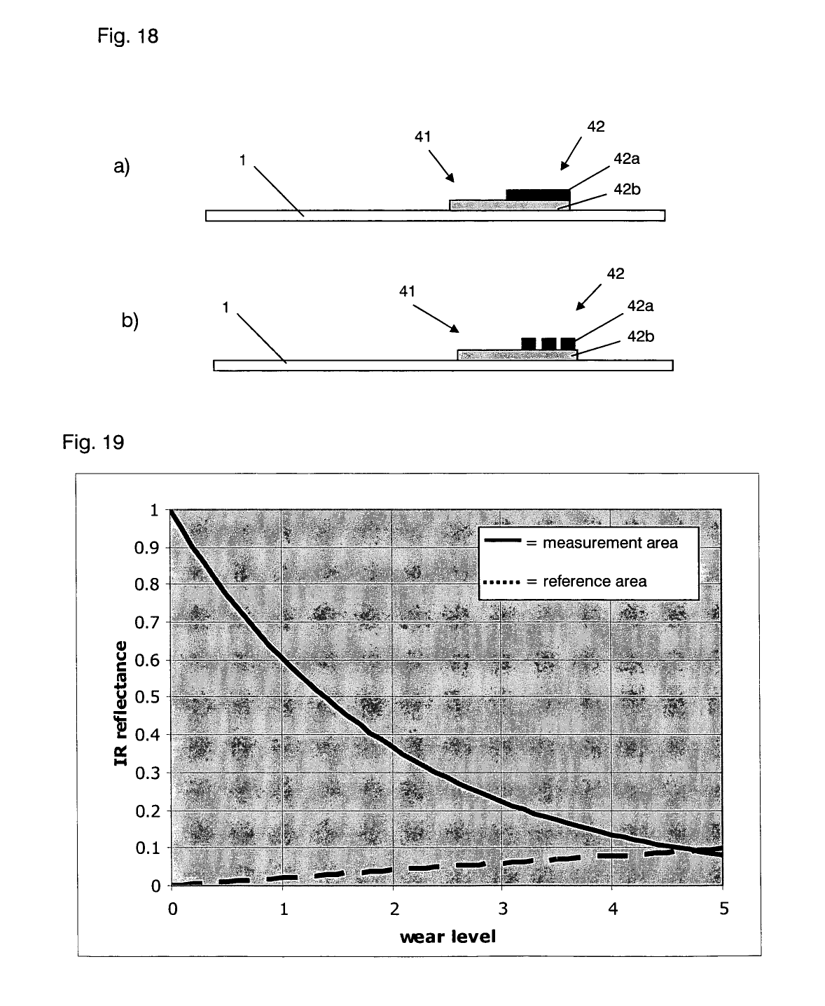

FIG. 18 a and b show schematic cross-sections through the soil test feature of the seventh embodiment;

FIG. 19 shows the change in reflectance as wear level increases for an exemplary document according to the seventh embodiment;

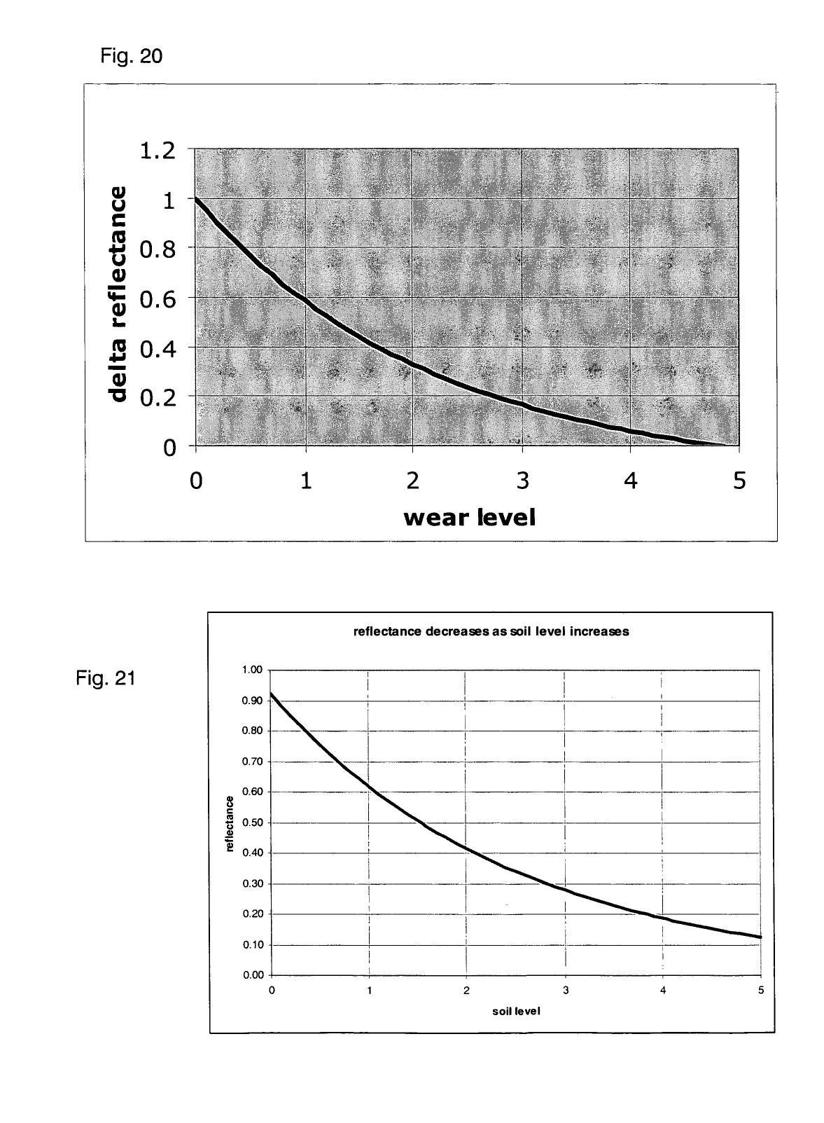

FIG. 20 shows the change in the reflectance difference as soil level increases for the exemplary document of FIG. 19; and

FIG. 21 shows the variation in absolute reflectance for an exemplary document according to any of the embodiments as soil level increases.

Various examples of documents incorporating a soil or wear test feature will now be described. As indicated above, the soil test feature finds particular application in currency, in particular on banknotes, but could be used analogously on any other type of document of value.

Since the soil level of a banknote and its wear level generally increase in step with one another, the two are intrinsically linked. As such, a measure of a document's soiling level will also provide an indication of its wear level, and vice versa.

In general, a soil or wear level test feature comprises two regions of the banknotes which are arranged to have different responses to the presence of dirt and/or to wear. The response of each region is detected by measuring a selected property of the regions. For example, the property could be the reflectance, transmittance, light scatter, gloss, roughness, luminescence, fluorescence, magnetism, or thermal emissivity of the regions, or any other suitable property which can be measured. The property may be affected by soiling (e.g. colour, reflectance), by wear (e.g. magnetism, roughness) or both (e.g. luminescence, fluorescence).

In the following examples, the reflectance of each area is used as the selected property and this can be detected using a conventional detector arrangement, illuminating the areas with light and using a photodetector to receive reflected light. The incident light may be monochromatic or broadband (e.g. white light), but in the latter case it is preferred to provide a spectral filter between the light source and the detector to specify the wavelength (or waveband) of interest. Other properties listed above can be measured using appropriate standard detectors.

The reflectance R of the two areas is measured at a chosen wavelength and the difference Δ between the reflectances of the two areas is calculated to give an indication of the soiling level. If desired this can be used as an indicator of wear level.

The difference in soil response of the two areas leads to a change in the measured difference Δ as the soil level increases. Typically, the area which is arranged to be more sensitive to soil is termed the “measurement area”, and the region which is arranged to be less sensitive is termed the “reference area”. Since both regions are equally or similarly affected by variations in print density, paper colour and paper roughness, by determining the reflectance difference Δ the accuracy of the soil level indication is greatly improved. In particular, the indication is largely unaffected by variations in the print or paper.

In some circumstances, all that may be required of the technique is to classify the notes with an indication of soiling in terms of the reflectance difference Δ value. However, typically, this value is used to determine whether a note is fit for re-issue or not. As such, once the Δ value has been calculated, it is typically compared with a set of criteria defining notes which are fit for re-issue (or conversely, unfit). This may, for example, constitute a predetermined threshold Δ value. The notes may then be sorted according to whether or not the Δ value measured meets the predetermined criteria.

Δ reflectance can be calculated in many areas of the note and then an average taken so as to increase the representative area and hence the accuracy of the soiling level determination.

It should be noted that various measures of reflectance R can be used. For example, in 3-D colour space (a*, b*, L*), the vector E can be defined where

E=(a*²+b*²+L*²)^{1/2}

ΔE then becomes the measure of soiling.

Alternatively the luminance L from the colour space (L*, a*, b*) can be used, or the fraction L of incident to reflected light.

A number of different ways to provide the measurement and reference areas have been identified and will now be discussed.

In a first implementation, the soil test feature comprises two regions of print on the banknote surface, one having dominant light reflection below 550 nm (the measurement area), and the other with its dominant light reflection above 550 nm (the reference area). Since typical soil found on banknotes is predominantly reflective over 550 nm, its presence on each of the printed regions affects the reflectance of each differently.

A first embodiment is shown in FIG. 2 which depicts a banknote B having a soil level test feature 10 disposed thereon.

The banknote B comprises a substrate 1, typically made of paper or polymer, on which is printed a graphics layer 2. The graphics layer 2 typically includes recognisable indicia such as pictorial design 3a (in this case a portrait) and letters or numbers 3b, 3c and 3d, here designating the numeral “200”. The indicia are typically surrounded by background prints such as 4a, 4b and 4c which are of relatively uniform appearance compared with the indicia. The graphics layer may also include one or more regions which are not printed.

Commonly, the graphics layer incorporates security features such as fine line prints and guilloches, and parts of the graphics layer may be printed using techniques such an intaglio which increase the difficulty of counterfeiting the banknote. Other security features such as security threads (magnetic or otherwise), holograms, optically variable inks, watermarks and embossings may be incorporated in or applied to the banknote as desired.

The soil test feature 10 comprises a first region 11 which is printed with a material which primarily reflects light above 550 nm in wavelength. For example, the region 11 may be yellow. This region 11 constitutes the reference area of the soil test feature 10 when reflectance is measured around the 450 nm region of the spectrum.

Adjacent the reference area is measurement area 12 which comprises a second region of the banknote surface which is printed with a material which reflects primarily below 550 nm. For example, the measurement area 12 may be printed in blue.

The reflectance of the measurement area 12 is affected by the presence of soil to a greater extent than that of the reference area 11. This is because the dominant light reflection of the measurement area 12 is effectively cancelled by the accumulation of soil which tends to absorb light below 550 nm and to reflect only higher wavelengths. In contrast, the reference area 11 reflects similar wavelengths to the spectral response of soil, and its reflectance therefore change relatively little compared to that of the measurement area 12. As more soil accumulates on the banknote, the reflectance difference Δ between the two regions changes. Variations in the base colour (that of the substrate 1) or the overprint (the graphics layer 2) affect both regions equally, and are therefore effectively cancelled out when the difference in reflectance is calculated.

Since soil itself mainly absorbs in the blue region and reflects in the yellow region of the spectrum, as shown by FIG. 1, it is advantageous to use blue and yellow printed areas as measurement and reference areas respectively.

It is preferred that the measurement and reference areas 11 and 12 are printed with substantially equal optical density in order to improve the accuracy of the measurement. In particular, it is desirable for both regions to be printed with sufficient ink density that they are effectively opaque: the underlying paper and print making no substantial contribution to the reflectance of each region. In this case, the nature of the document in the region underlying the soil level test feature 10 is of little significance, and the feature's location on the note can be decided based on other factors such as aesthetics and the overall design of the document. Nonetheless, in many cases it is preferable for the feature to be provided over a portion of the graphics layer which is relatively uniform (i.e. constituting part of the background or an unprinted area).

It is clearly a limitation of this method that the printed regions 11 and 12 themselves could be subject to some variation due to print set-up and ink variations. It is therefore important that the colour and print density of these regions is closely controlled during the manufacturing process. However, these factors are relatively straightforward to control compared for example with the colour of the underlying paper substrate.

In the embodiment shown in FIG. 2, the measurement and reference areas are provided in the form of adjacent rectangular blocks, with approximately the same dimensions and abutting one another. However, the regions 11 and 12 can be provided in any convenient arrangement, such as lines or even complex shapes such as graphics. Nonetheless, for use with presently available detectors, each region should preferably have width dimensions of 2 mm or more in order to enable accurate measurement of reflectance by a detector over a significant proportion of each region. It is not essential that the regions abut one another as shown in FIG. 2, but it is preferable that the borders of the two regions are within approximately 2 mm of one another (or not more than 5 or 10 mm) in order that they may be used to obtain a representative measure of the soiling in that part of the note.

An alternative arrangement is depicted in FIG. 3. In this second embodiment, the reference area 11′ and measurement area 12′ making up the soil level test feature 10′ are disposed along opposite edges of the banknote B. In all other respects, they are formed as described above with reference to FIG. 2. In this example, the reference area 11′ and measurement area 12′ are provided spaced from one another by the width of the note. However, as indicated above, in many cases it is preferred to arrange the two regions adjacent to one another and so the FIG. 3 arrangement could be modified to have both reference and measurement regions along both the top and bottom edges of the note.

Arranging each region to be elongate parallel to one of the edges of the document (in this case the long edge of the banknote) is advantageous since, when the note is sorted using a sorting machine, it will typically be transported past a detector in a direction parallel to one of its edges. In this example, if the note is transported short edge first, the detector will be able to view each of the regions 11 and 12 for an extended duration. This improves the accuracy of the measured reflectance, and so the soil indication.

The regions 11′ and 12′ could of course be provided parallel to the short edge of the banknote for suitability in sorting machines which transport banknotes long edge first. Preferably, however, two soil level test features 10′ are disposed on each banknote, one parallel to the long edge of the note (as shown), and another parallel to the short edge of the note (not shown). In this way, the note is suitable for testing by any sorting machine. To avoid potential problems caused by off-centred notes or skewing, each soil level test feature 10 is preferably spaced from the edge of the note by a few millimetres (or extends at least this far from the edge of the note).

To assist in camouflaging the feature on the banknote, it may be preferred to form either or both of the regions from a plurality of sub-regions, i.e. discrete portions of the banknote surface which are each arranged to have the appropriate response to soiling. Sub-regions making up the reference area (“first sub regions”) will each, in this embodiment, be printed to reflect primarily above 550 nm, and sub-regions making up the measurement area (“second sub regions”) will each be printed to reflect primarily below 550 nm.

FIGS. 4a and 4b show the variation in reflectance L* across the soil level test feature 10 shown in FIG. 2 along the line X-X′. FIG. 4a shows the reflectance of two clean notes: a first note with relatively dark printing in trace i), and a second note with relatively light printing in trace ii). For each note, the difference ΔL between the peaks, which represent reference area 11, and troughs, representing measurement area 12, is the same, even though the traces are offset from one another, due to the printing variation.

FIG. 4b shows the same two notes with soiling. It will be seen that the difference in reflectance Δ between the peaks and troughs is now significantly reduced, but still remains equal for the dark note and the light note.

FIG. 5 shows the spectral reflectance of each region 11 and 12 and their variation with soiling time. The set of traces generally designated “i” relate to the measurement area 12 (the blue region), and the set of traces “ii” relate to the reference area 11 (the yellow region). As soiling time increases (indicated by the number of minutes identified against each trace in the legend), the reflectance of each region shifts downwardly on the graph. It will be seen that, detecting at 450 nm (in the blue range of the spectrum), the reflectance of the measurement area 12 is initially high, and that of the reference area 11 is low. As soiling increases, the reflectance of the measurement area decreases rapidly, whereas that of the reference area undergoes little change. Thus the reflectance difference ΔL* undergoes a change (=ΔL*_{CLEAN}−ΔL*_{SOILED}), the magnitude of which gives an indication of the soiling level.

FIG. 6 shows the decrease in reflectance at 450 nm for each of the regions as the soil level increases. It can be seen that, whilst the reflectance of each area decreases, that of the measurement area is affected more by the presence of soil since its reflectance drops more sharply. As the soil level increases, the two traces begin to converge, causing a reduction in the ΔL* value. This is shown in FIG. 7 which depicts the decrease in ΔL* as the soil level rises. Hence the value of ΔL* can be used as a measure of soiling.

Graphics comprising line structures, such as very finely spaced lines (filigree or otherwise) are often preferred in security print because they can be used as anti-scan or copier features. They can also be difficult to replicate accurately using low cost print equipment. This method is particularly well suited to the measurement of soil over anti-copy regions whereby the first region comprises line structures in the reference colour and the second region comprises line structures in the measurement colour. Typically, the spaces between the lines in each region are unprinted or lightly printed and are substantially similar in the first and second regions.

To measure the selected property, such as reflectance, of each region, a combination of the line property and that of the spaces between lines can be measured for each region. For example, the field of view of a detector may include both lines and the spaces between such that the measured property value results from both the lines and the spaces. This can be repeated for both regions or just one or the other. In this way, the dimensions of the individual lines can be significantly smaller than permitted by the resolution of the detector.

It is preferred that the line structures have equal ink coverage in both the soil sensitive (measurement) and reference areas. It is also preferred that the line pattern in both areas is essentially identical. It is preferred that both areas are adjacent to one another. It is preferred that line patterns are symmetrical about the x and y axis so that measurement is not sensitive to errors caused by a combination of document misalignment and machine image capture or reflectance measurement astigmatism.

In a second implementation, the soil level test feature is provided by controlling the smoothness of the first and second regions relative to one another. This can be achieved in a number of ways, including varnishing (or otherwise coating) or smoothing (e.g. by calendaring) selected portions of the banknotes. Both varnishing and calendaring the surfaces of a banknote have been found to reduce the banknote's affinity for soil in the smoothed region. The reflectance of the smoothed region can then be compared with a region having less (or no) varnish, or an uncalendared region, to determine the difference in reflectance Δ.

FIG. 8 shows a third embodiment of a document of value in the form of a banknote B of substantially the same construction as described above with respect to the first and second embodiments, apart from the soil level test feature. Here, the soil level test feature 20 comprises a varnished reference area 21 and an unvarnished measurement area 22. Since the varnish is typically transparent or translucent, the soil level test feature 20 is preferably provided over an area of the note which is either unprinted or uniformly printed with a background image, for example with a fine line offset print as commonly found on banknotes. Suitable varnish types include those based on polyacrylate, polyurethane or nitrocellulose-based resins, or blends of any of these systems, although many other types of varnish could also be used.

To maintain a high level of measurement accuracy, the varnished region(s) preferably cover at least 5% of the surface of the document, even more advantageously at least 10% of the surface of the document. The varnished region 21 shown in FIG. 8 covers approximately 5% of the document surface. However, this may not be appropriate if the overriding preference is to conceal the feature on the document, in which case a smaller area may be coated.

It should be noted that the outlines shown bounding the varnished region 21 are for clarity only and would typically be omitted from the final product in order to make the soil level test feature as unobtrusive as possible.

When a note is clean, the varnished and unvarnished areas have substantially the same reflectivity. As the note becomes soiled, the varnished area 21 collects less soil than the unvarnished measurement area 22 and the difference in the reflectivity Δ of the two regions is therefore a direct measure of soil pick-up that is independent of print or paper colour variations.

It has been found that a document's affinity for soil decreases as the thickness of a varnish layer increases. As such, it is also possible to use this technique with documents having an all over soil protective coating or lacquer by providing an additional layer of varnish printed over or under the protective coating in the reference region 21. In the reference area 21, the increased thickness of varnish causes less pick-up of soil compared to the measurement region which has a thinner layer of varnish thereon.

A typical layer of varnish has a thickness of between 1 and 5 gsm (grams per square metre), typically around 2 to 3 gsm. Therefore on uncoated documents, it has been found that a varnish of approximately 2 gsm in the reference area is appropriate. If the document already has a base coat of varnish acting as an all over soil protective coating or lacquer, a thickness of around 4 gsm in the reference area is needed (i.e. approximately twice that of the surroundings). In general the reference region may have a varnish thickness of between 1 and 5 gsm, and the measurement region a varnish thickness of between 0.5 and 2.5 gsm. The difference in varnish thickness between the two regions is preferably between 1 and 5 gsm, usually around 2 to 3 gsm. It is important that the varnish coat weight is well controlled so that the soiling difference between the varnished and unvarnished areas is consistent. It is also preferred that the varnished and unvarnished areas which make up the reference and measurement areas respectively are positioned over equivalent areas of the document such as regions of unprinted substrate or, more generally, regions having substantially the same colour and print density.

Since it is the varnished region that will be used as the reference area, it is preferable to have the varnish coat weight as high as practicable so that the variation in reference level is minimal. This then allows the Δ reflectance to be more accurate measure of soil level. Experimental results have shown that a thicker layer of varnish will soil at a slower rate and therefore a greater Δ value can be achieved, where practical, by applying a very thick layer of varnish in the reference area, for example in excess of 10 gsm.

An advantage of the varnishing technique is that there is little or no impact on the design of the graphics layer 2, since any features occurring underneath the varnished region 21 remain visible. This makes it possible to provide a relatively large region of varnish and so achieve a more representative measure of the level of soiling since more of the banknote's surface area is tested.

As shown in FIG. 8, the varnished area 21 and unvarnished area 22 may conveniently be provided adjacent one another. An alternative arrangement is shown in FIG. 9 in which the varnished region 21′ comprises a plurality of sub-regions which are spaced from one another across the banknote, and any convenient portion 22 of the surrounding unvarnished area can be used as the measurement area. As noted with respect to the first and second embodiments, the regions making up the soil test feature 20 need not abut but are preferably adjacent one another, as shown for example in FIG. 9.

In order to conceal the feature on the banknote, the varnished and/or unvarnished regions may each be made up of a plurality of sub-regions dispersed across an area of the banknote, as depicted in FIG. 9. In particular examples, the varnished area may take the form of a line structure or half-tone structure (such as a checkerboard pattern) of a clear or translucent varnish. In such cases, the first sub regions and second sub-regions are effectively interspersed with one another. It will be appreciated that, in the FIG. 9 embodiment, the measurement area could be located between varnished sub-regions 21 rather than spaced apart as depicted in the Figure.

As an alternative to providing the soil test feature 20 over a background region of a banknote, it is possible to arrange the varnish and unvarnished areas to coincide with indicia such as numerals 3b, 3c and 3d shown on FIG. 8. What is important is that the print underneath the two regions is of substantially equal colour and optical density. Thus, both regions could be provided over one indicium, such as the numeral “2” indicated as 3b, by varnishing a portion of the numeral and leaving the rest unvarnished. Alternatively, one or more of the numerals 3b, 3c or 3d, could be varnished and at least one of the others left unvarnished. Nonetheless, it is preferred that the minimum dimensions of the indicia are at least 2 mm in any direction to ensure that a detector will be able to identify its position with sufficient accuracy.

The alternative of creating a localised smooth region using a compressive smoothing process (such as calendaring, embossing or blind intaglio printing) can be implemented exactly as described above with respect to FIGS. 8 and 9 replacing varnished regions with locally smoothed areas. Like the varnished area, smoothed areas pick up less soil and so provide a reference against which adjacent regions of the note can be compared.

FIG. 10 shows the variation in reflectance L* across the soil level test feature 20 of FIG. 9 along the line Y-Y′, having alternating varnished and unvarnished regions. FIG. 10a shows the reflectance of two clean notes: a first note with relatively dark printing in trace i), and a second note with relatively light printing in trace ii). FIG. 10b shows the same two notes after handling and shows the reflectance difference ΔL to have increased significantly. However, the measure ΔL is the same for the two banknotes. In this case the reference area showing the least change in L* due to soil is the varnished area and would be represented by the peaks of the trace.

FIG. 11 shows how the reflectance at 450 nm of a varnished region (reference area) and that of an unvarnished region (measurement area) change with soiling level. It will be seen that the reflectance of the uncoated region initially decreases rapidly compared with that of the coated region but begins to approach the coated regions reflectance at very high soiling levels.

FIG. 12 is a corresponding graph showing the change in Δ reflectance for the FIG. 11 document and it will be seen that there is a peak in Δ reflectance at a soil level of between 1 and 2 (arbitrary units).

In a third implementation, the soil level test feature is formed by applying a relief to the banknote surface. It has been found that regions of paper that are below the mean surface height pick up less soil than adjacent areas. Similarly, regions of the paper that protrude above the average paper surface soil more than adjacent areas. FIGS. 13 and 14 show two alternative ways of achieving such relief in a document.

FIG. 13 shows schematically a cross-section through a document containing a watermark. FIG. 13a shows a region 32 which is raised relative to its surroundings. FIG. 13b shows a region 31 which is depressed relative to its surroundings.

As the skilled man familiar with watermarking techniques will appreciate, the relative raising or lowering of the regions 31 and 32 is caused by controlled variations in the paper density (defined by grams per square meter). In practice, this can be achieved in a number of ways, for example using the electrotype watermarking technique in which, during the paper making process, metal plates defining regions which are to be of reduced paper density, are placed on the plane where the paper is to be formed. As the paper fibres are applied, fewer fibres settle on top of the plates, thereby arriving at a reduced paper thickness in these regions, and thereby a lighter appearance since the opacity of the paper is locally reduced. The smaller dimension of such electrotype plates is limited to a maximum of around 1.5 to 2 mm to avoid extreme thinning of the paper, which could lead to holes (however it is possible to have larger dimensions in the perpendicular direction, e.g. regions of ˜2 mm wide by ˜2 cm long).

Alternative watermarking processes can also be employed, such as the shadow technique in which paper is formed on an embossed metal mesh, the peaks and troughs of which lead to light and dark areas of the paper respectively.

In contrast, the embossing technique, as shown in FIG. 14, does not involve any variation in paper density. Rather, the substrate is simply deformed by the embossing process out of the plane of the sheet. FIG. 14a shows a cross-section through an embossing with a raised portion 32′ on the side of the paper which is of interest, and FIG. 14b shows a depressed region 31′ in cross-section.

During use, portions of the watermark or embossing which are raised collect more soil since these are the parts which come into contact during handling. The raised portions also provide a shielding effect which prevents soil getting into the lower regions located between them. As such, the raised portion(s) of the watermark or embossing form a measurement area 32, and the lower parts form a reference area 31, together making up a soil level test feature 30.

In other embodiments the raised area itself can be a measurement area and an unchanged area similar in other characteristics (i.e. without Intaglio prints or windows and with same print colour and type) can be the reference area.

In yet another embodiment the lower parts can be the measurement area while the unchanged area similar in other characteristics (i.e. without Intaglio prints or windows and with same print colour and type) can be the reference area.

It has been found that this effect occurs most strongly where the localised raised and lower regions are of reasonably narrow dimension. In particular, it is preferred that each of the regions should have minimum dimensions in the plane of the document of not more than 4 mm and preferably not more than 2 mm. Larger regions tend to pick up the same level of soil as the surrounding unmarked regions.

Depending on the resolution of the detectors available, it may be difficult to measure the reflectance of individual regions with a minimum dimension equal to or below 2 mm wide, so by measuring the reflectance over an area comprising several such regions (i.e. a plurality of sub-regions), it becomes possible to measure the difference between the reflectance of the raised and unraised areas.

It should be noted that depending on the watermarking or embossing technique, and the desired design of the feature, the “raised” or “lower” regions may in fact be level with the plane of the document (for example, the watermark may consist only of depressions, the surrounding area of the banknote surface providing the relatively raised regions). What is important is that there is a relative height difference between the reference and measurement areas.

FIG. 15 shows a fourth embodiment of a document of value having a soil level test feature 30 comprising a reference area 31 incorporating depressed features formed by watermarking or embossing, and a surrounding measurement area 32 which is not watermarked or embossed. In the FIG. 15 embodiment, the reference area 31 is formed of a plurality of sub-regions in the form of five rectangular bars spaced from one another by sub-regions of the measurement area 32. The soil level test feature 30 is preferably provided on a portion of the banknote which is unprinted or relatively unprinted (e.g., comprising a background print) in order to avoid any discrepancy between the effect of the print on the measurement area 32 and on the reference area 31.

In this example, the sub-regions forming reference area 31 are spaced along a direction which is parallel to one of the edges of the banknote B: here its long edge. During sorting, using a machine in which the banknote is transported short edge first, this allows the detector to view the sequence of sub-regions and so be able to measure to the reflectance of each to thereby obtain a representative sample of the feature.

FIG. 16 shows an alternative embodiment in which several soil test features 30a to 30d are depicted. It should be noted that, in practice, just one or any selection of these features might be provided on the note. A soil test feature 30a is provided adjacent an edge of the banknote and the sub-regions making up reference area 31 and measurement area 32 are spaced along the short edge of the note, suitable for detection in sorting machines in which the note is transported long edge first using the technique described above in relation to FIG. 15. In order that the note can be tested using any sorter type, an additional soil level test features 30b of the same construction is provided which is arranged parallel to the long edge of the note to enable detection in short edge first sorting machines.

However, in other cases it may be preferable to arrange the regions to run parallel to the direction of motion of the note past the detector, to enable an average of each line to be taken. Soil test features 30c and 30d are examples of this, one provided parallel to the short edge and one provided parallel to the long edge to enable the measurement to be made by any sorter type.

Typically, either pair 30a and 30b, or pair 30c and 30d would be provided on the note. However, all four could be provided depending on the set-up of likely sorting machines.

It should be noted that, as in the case of printed soil level test features described above, to measure the property (e.g. reflectance) of the reference and measurement regions, the detector may be arranged to view a portion of the note over which the property varies such that the measured value results from the combination of the various features viewed. For example, in the FIG. 16 embodiment, to measure the reflectance of the measurement region, the whole of the feature 30a (or a part thereof) containing raised lines 31 could be viewed by a detector and the representative reflectance recorded. The reference value could then be taken from another portion of the note which has the same properties as spaces 32 between the lines 31 (e.g., an unwatermarked region), or from a designated separate reference region (not shown) which includes depressed lines.

In practice, the sorter may use X-ray or Infra-red detection to locate the watermark feature and then measure the reflectance over the identified area.

The variation of reflectance and Δ reflectance achieved by soil test features of the sort shown in FIGS. 15 and 16 follows substantially the same trends as depicted in FIGS. 11 and 12.

In a fourth implementation, the measurement and reference areas of the soil test feature are arranged to measure banknote wear rather than soiling. As already noted, it has been found that, in general, soiling and wear follow similar trends. As such, by measuring the wear level of a note, the amount of soiling can be inferred.

In general, the measurement region comprises a structure which is frangible relative to the reference region. That is, it will suffer damage during handling more readily than the reference area.

FIG. 17 shows a sixth embodiment of a document of value which incorporates such a soil test feature 40. The reference area 41 comprises a region which has a known predetermined reflectance or other property, such as magnetism. In practice, this may be provided as a purpose-designed print or could simply comprise a portion of the normal banknote print or the unprinted substrate. The measurement area 42 includes a layer which is formulated to wear out relatively quickly as the note is handled. This layer has a predetermined reflectance (or other same property) which is difference from that of the reference area 41. As the frangible layer wears down, the reflectance of the measurement area 42 changes from that of the frangible layer to that of the underlying note. This can be compared with the reflectance of the reference area 41 to provide an indication of the wear level and hence the amount of soiling.

In some cases, the measurement feature 42 can comprises a single frangible ink layer on a relatively uniform portion of the bank note B, the reflectance of which is then compared with the surrounding note. As the frangible layer is worn off, the reflectance of the measurement area 42 nears that of the underlying note and so approximately equals that of the reference area 41

An alternative construction involves printing reference area 41 with a material of a predetermined reflectance, and providing measurement area 42 with a two-layer structure, the upper layer of which is relatively frangible. As the upper layer wears away, the lower layer is revealed and the reflectance of the area changes to that of the lower layer. This can be compared throughout with the reflectance of the reference area 41 to thereby deduce the level of wear (and hence soil).

In a particularly preferred embodiment, the reference area 41 and the lower layer of the measurement area 42 are arranged to have the same reflectance. FIG. 18 shows cross-sections though the soil level test feature 40 a) on an unused note, and b) on a used note. It will be seen that the material forming reference area 41 is identical to that of the lower layer 42b of the measurement area 42. The lower layer 42b of the measurement feature 42 is initially covered entirely with an upper layer 42a having a different reflectance. The layer 42a is typically formulated with a lower binder concentration to increase its susceptibility to wear. Thus, over the life of a banknote, the reflectance of the measurement area 42 becomes more similar to that of reference area 41. The difference between the reflectance at a selected wavelength (or some other measure of a suitable property, preferably an optical characteristic) of these two regions can then be used to determine the amount of handling the note has received, and so estimate the soil level.

As with other print methods, this feature is dependent on accurate printing of the colour and print density of the feature, but it is not affected by variations in paper colour.

The contrast between the frangible layer and the layer (or note surface) underneath ideally is as great as possible. One way of achieving this is to use inks that absorb radiation at opposite ends of the spectrum, for example red and blue, or IR reflective and an IR absorptive ink.

FIG. 19 shows the IR reflectance of a IR-reflective frangible structure (measurement area) as it decreases during handling alongside that of the non-frangible reference area. It will be seen that there is a sharp decrease in the IR reflectivity of the frangible area, whereas there is little change in the reference area and indeed its IR reflectance may be found to increase slightly if, for example, the reference area contains an IR absorbing ink, which will wear off to a small extent during use. FIG. 20 shows the corresponding Δ reflectance variation.

The frangible structure can be formed using a number of printing techniques including intaglio printing or lithographic printing. In each case, the frangible layer will typically be designed to have a lower binder content than that of adjacent portions of the banknote print.

The use of materials such as IR reflecting and IR absorbing inks make it possible to arrange for a frangible layer and the colour underneath to have the same or similar visible colour, such that any change in the feature would not be perceived by a user whilst remaining readily detectable by a machine viewing the feature at IR wavelengths.

Similarly, it may be desirable to utilise X-ray absorbing and non-absorbing inks and carry out the detection using X-rays. For example, an X-ray absorbing ink (such as a metallic ink) could be used as the frangible layer, so casting a high X-ray shadow. As this wears away, the feature would become more transmissive to X-rays, casting an increasingly low x-ray shadow.

The level of X-ray shadow can be compared with an adjacent (non-frangible) portion of the banknote which is either X-ray opaque or transparent, as a reference area.

The use of X-ray detection could be used in combination with IR detection. For example, the upper layer 42a of measurement area 42 could comprise a X-ray opaque metallic ink, and the lower layer 42b an IR absorbent material. Thus, the detection of wear would be carried out by both checking that the X-ray shadow is reduced and that the IR absorbance has increased. This improves the accuracy of the sorting technique since potential false results are avoided. For example, an oil smear on the banknote would absorb infrared (and so appear as if the frangible layer had been worn away), but X-ray analysis would reveal that the opaque frangible layer had not in fact worn out such that the note is able to continue in use.

The detection method for determining the soil level is common to all of the above implementations. As described above, the measured difference in reflectance (or other property) Δ between the measurement area and the reference area gives an indication of the soiling level. Typically, this is compared with predetermined criteria to determine whether the soil level is acceptable (i.e. the note is fit for re-use) or whether the note should be taken out of circulation. The notes will typically then be sorted to appropriate storage means accordingly.

In general, it is preferred to measure the reflectance of each area at a wavelength which is highly sensitive to the presence of soil. This could for example involve wavebands below 500 nm (e.g. blue light) or infrared wavelengths of between 750 nm and 1 μm.

In embodiments utilising a plurality of sub-regions for either the measurement area and/or the reference area, to determine the reflectance of each area, at least some of its sub-regions will be measured and an average reflectance computed. It would be preferable to take a reflectance measurement from every one of the sub-regions provided, but in practice this may not be necessary or possible given time and geometry constraints on the detection process.

The average reflectance of the sub-regions can then be used to determine the difference Δ in average reflectance between the sub-regions of the reference area and those of the measurement area to give an indication of the soil level.

If more than one soil level test feature is provided on a banknote, such as described with reference to the FIG. 16 embodiment above, typically the reflectance difference will be determined for at least some of the soil level test features. The resulting Δ values could then be averaged to indicate an average soil level for the entire note. However, it may be preferred to compare each of the Δ values with corresponding predetermined criteria to determine whether any of the various areas on the note pass or fail their respective fitness criteria.

It should be noted that any combination of the various types of soil level test features described in the above embodiments could be disposed on a single note. For example, a printed soil level test feature such as that described in the first embodiment could be provided together with a varnished soil level test feature such as that of embodiment three on one document.

In order to measure the soiling of notes that pass through the used note sorting machines (UNSMs), it is preferable to have at least one soil level test feature on each side of the note.

In practice, a template will be stored for each note identifying the location and format of the soil level test feature(s), and defining the predetermined criteria for each soil level test feature thereon. The criteria used to determine whether the soil level is acceptable may vary between notes and, moreover, between soil level test features provided on one note (especially if the soil level test features are of different types).

The notes may then be sorted based on whether any of the soil test features, or a certain number of the features, pass or fail their respective predetermined criteria.

As mentioned above, in some implementations the Δ value (whether the measured property is reflectance or otherwise) may reach a maximum (or minimum) at a certain soil or wear level. For example, in the FIG. 9 embodiment, the corresponding Δ graph (FIG. 12) shows that, once soiling or wear reaches a certain level, the difference in reflectance between the two regions becomes non-linear and typically increases to a peak before reducing once more. The maximum (or minimum, in a case where initial soiling or wear decreases Δ) typically occurs at a relatively high level of soiling or wear, which may not often be encountered in currencies operating a clean-note policy. However, if it is envisaged that such notes might be encountered, in certain embodiments it is useful to measure the absolute reflectance of an area of the document, preferably the measurement area (i.e. the region most sensitive to the level of soil) in addition to the reflectance difference Δ. An exemplary graph depicting the change in absolute reflectance of a document as the soil level increases is shown in FIG. 21. The measured absolute reflectance value can be compared directly with a threshold which, once passed, indicates that the note is clearly unfit for use, irrespective of any variation in print and paper colour. All notes which pass the test can then go on to be judged by means of their reflectance difference Δ value.

The absolute property value measured need not be the same property as measured in order to determine the Δ value—for example, the absolute property measured could be the transmittance of the document whilst the Δ value used to measure soiling level could be Δ reflectance. However, it is convenient to use the same property and hence in the embodiments given above, the absolute reflectance would preferably be used.

1-111. (canceled)

112. A document of value comprising a soil or wear level test feature for determining the soil or wear level of the document of value, the soil or wear level test feature comprising:
a reference area comprising a first region of the document; and
a measurement area comprising a second region of the document;
wherein a property of the measurement area is affected by the presence of soil or wear differently to the same property of the reference area, such that the difference in the property between the reference area and the measurement area provides an indicator of the degree of soiling or of the degree of wear of the document of value.

113. A document of value according to claim 112, wherein the property of the reference and measurement areas is reflectance, transmittance, light scatter, gloss, roughness, luminescence, fluorescence, magnetism, or thermal emissivity.

114. A document of value according to claim 112, further comprising a substrate and a graphics layer thereon having one or more printed images extending over at least part of the surface of the document of value, the graphics layer being disposed between the soil or wear level test feature and the substrate, or over the soil or wear level test feature.

115. A document of value according to claim 112, wherein the first region comprises a plurality of first sub-regions collectively forming the reference area.

116. A document of value according to claim 112, wherein the second region comprises a plurality of second sub-regions collectively forming the measurement area.

117. A document of value according to claim 112, wherein the first region is printed with a first colour reflecting primarily at wavelengths of above 550 nm to form the reference area, and the second region is printed with a second colour reflecting primarily at wavelengths of below 550 nm to form the measurement area.

118. A document of value according to claim 112, wherein the surface of the document in the first region is adapted to have a lower affinity for soil than that in the second region.

119. A document of value according to claim 118, wherein the first region is provided with a soil resistant film thereon.

120. A document of value according to claim 119, wherein the first region is coated with a layer of varnish, the thickness of which is greater than that of any varnish layer in the second region.

121. A document of value according to claim 120, wherein the second region is unvarnished.

122. A document of value according to claim 120, wherein the difference in varnish thickness between the first and second regions is between 1 and 5 gsm, preferably between approximately 2 to 3 gsm.

123. A document of value according to claim 118, wherein the first region is smoothed relative to the second region by application of a compressive force in the first region.

124. A document of value according to claim 123, wherein the first region is calendared and the second region is not calendared, such that the surface of the document is smoother in the first region than in the second region.

125. A document of value according to claim 112, wherein the surface of the document in the second region is raised relative to that in the first region.

126. A document of value according to claim 125, wherein the soil or wear level test feature comprises an embossing, the first region comprising a portion of the document distorted below the plane of the document, and the second region comprising a portion of the document distorted above the plane of the document.

127. A document of value according to claim 125, wherein the soil or wear level test feature comprises a watermark, the first region having lower paper fibre density than that of the second region.

128. A document of value according to claim 112, wherein the second region comprises a frangible structure adapted to wear relatively fast compared to the first region of the document.

129. A document of value according to claim 128, wherein the second region comprises a lower layer of first reflectance, and an upper layer thereon of second reflectance differing from that of the lower layer, wherein the upper layer is relatively frangible compared to the lower layer.

130. A document of value according to claim 112, wherein the document of value is a banknote, certificate, passport or other security document.

131. A method of making a document of value according to claim 112, comprising:
providing a printed document of value comprising a graphics layer; and
applying a soil or wear level test feature to the printed document of value, the soil or wear level test feature comprising: a reference area comprising a first region of the document; and a measurement area comprising a second region of the document; wherein a property of the measurement area is affected by the presence of soil or wear differently to the same property of the reference area, such that the difference in the property between the reference area and the measurement area provides an indicator of the degree of soiling or of the degree of wear of the document of value.

132. A method according to claim 131, wherein the soil or wear test feature is applied to the document of value by printing, preferably lithographic printing, intaglio printing, letterpress printing, flexographic printing, rotogravure printing or screen printing, or any combination of these techniques.

133. A method according to claim 131, wherein the soil or wear test feature is applied to the document of value by varnishing or otherwise coating.

134. A method according to claim 131, wherein the soil or wear test feature is applied to the document of value by smoothing the surface of the document, preferably by calendaring.

135. A method according to claim 131, wherein the soil or wear test feature is applied to the document of value by embossing, preferably blind intaglio printing.

136. A method according to claim 131, wherein the soil or wear test feature is applied to the document of value by application of a frangible material to the document surface, preferably by printing a frangible ink.

137. A method according to claim 131, further comprising the step of providing the document of value with a protective varnish layer, before applying the soil or wear level test feature.

138. A method of detecting the soil or wear level of a document of value, comprising:
a) measuring a property of a reference area of the document, the reference area comprising a first region of the document;
b) measuring the same property of a measurement area of the document, the measurement area comprising a second region of the document, wherein the property of the measurement area is affected differently by the presence of soil or wear to that of the reference area; and
c) calculating the difference between the measured property of the reference area and the measured property of the measurement area, the calculated difference providing an indicator of the degree of soiling or of the degree of the document of value.

139. A method according to claim 138, further comprising:
d) determining whether the calculated difference in measured property meets predetermined criteria defining an acceptable soil or wear level.

140. A method according to claim 138, wherein the measured property is reflectance and, in steps a) and b), the reflectance of the reference and measurement regions is measured at a selected waveband which is narrow compared to the visible spectrum.

141. A method according to claim 140, wherein the waveband defines monochromatic radiation, preferably blue with a wavelength below 500 nm, or infrared with a wavelength between 750 nm and 1 mm.

142. A method according to claim 138, wherein the first region comprises a plurality of first sub-regions and the step of measuring the reflectance of the first region comprises measuring the property of at least some of the plurality of first sub-regions and computing an average property value.

143. A method according to claim 138, wherein the second region comprises a plurality of second sub-regions and the step of measuring the property of the second region comprises measuring the reflectance of at least some of the plurality of second sub-regions and computing an average property value.

144. A method according to claim 138, further comprising:
i) measuring the absolute property value of the reference and/or the measurement areas;
ii) determining whether the absolute property value meets a reject criterion; and
iii) processing the document of value based on the outcome of the determination in step ii).

145. An apparatus for determining the soil or wear level of a document of value, comprising a detector assembly adapted to detect a property of a reference area of the document and of a measurement area of the document and to generate corresponding output signals, and a processor adapted to receive the output signals from the detector assembly, perform the method of claim 138, and thereby output an indicator of the degree of soiling or of the degree of wear of the document of value.

146. A computer program product containing instructions for performing the method of claim 138.
